(19) United States
(12) Patent Application Publication
(10) Pub. No.: US 2023/0053181 A1
(43) Pub. Date: Feb. 16, 2023

(54) MOTION LEARNING SYSTEM

(71) Applicant: NIPPON TELEGRAPH AND TELEPHONE CORPORATION, Tokyo (JP)

(72) Inventors: Masumi YAMAGUCHI, Tokyo (JP); Daiki NASU, Tokyo (JP); Toshitaka KIMURA, Tokyo (JP)

(73) Assignee: NIPPON TELEGRAPH AND TELEPHONE CORPORATION, Tokyo (JP)

(21) Appl. No.: 17/792,390

(22) PCT Filed: Jan. 14, 2020
(86) PCT No.: PCT/JP2020/000890

§ 371 Date: Jul. 12, 2022

(51) Int. Cl. G09B 19/00; A63B 69/00

(52) U.S. Cl. CPC G09B 19/0038; A63B 69/0002; A63B 2102/18

(57) ABSTRACT

A kinetic motion learning device includes an information storage unit configured to associate and store in advance a pitching motion video and pitching trajectory information for a plurality of pitches actually delivered by a pitcher on a potential opponent team, and is configured to read a set of the pitching motion video and the pitching trajectory information stored in the information storage unit, output the pitching motion video being read to a projector, output the pitching trajectory information being read to a pitching machine, and control motion timings of the projector and the pitching machine so that a time of ball release of the pitcher in the pitching motion video displayed on a screen and a time of the pitching machine launching the ball with the pitching trajectory information match. The projector is configured to project the pitching motion video onto the screen so that the pitching motion video is displayed on the screen at a motion timing controlled by the kinetic motion learning device. The screen includes a hole through which a ball launched by the pitching machine can pass at a position of ball release of the pitcher in the pitching motion video displayed.

### TECHNICAL FIELD

The present invention is a system, a device, and a learning method for learning a habit of an opponent player in a competitive game, such as, for example, a system, a device, and a learning method for a batter in softball or baseball to learn a habit of an opponent pitcher.

### BACKGROUND ART

When hitting in softball or baseball, a batter needs to ascertain in a short period of time a pitch type and the like of a ball thrown by a pitcher and approaching at high speed, determine what kind of kinetic motion should be performed, and accurately carry out the target kinetic motion. When the batter knows the pitch type and the like before the pitcher throws the ball, the batter can start determining what kind of kinetic motion to perform from that moment, and is more likely to make a good hit as a result. The pitcher is therefore trained to minimize differences in pitching motion (so-called “delivery form”) between pitch types in order to reduce the possibility of the batter making a good hit.

Nevertheless, in order to throw balls of different pitch types, it is necessary for the pitcher to make the speeds, rotations, and the like applied to the ball different when the pitcher throws, and thus the pitching motion of the pitcher is always different depending on the pitch types of a throwing ball. That is, the pitching motion of the pitcher always includes a portion specialized for each pitch type. The portion specialized for the pitch type included in the pitching motion of the pitcher is generally called a “habit”. The habit is utilized as information to ascertain the pitch type when a batter is hitting.

On each team, the person responsible for information analysis or the like identifies the habit by watching the pitching motion of the pitcher on the opponent team in advance, and relays the identified habit to the batters on his/her own team by expressing the habit in words orally, in writing, or the like. Then, when actually playing a game, each batter utilizes the information related to the habit of the pitcher on the opponent team as information when hitting. For example, it is known that information related to habits expressed in words such as “when the pitcher throws a curveball, half of the ball appears to protrude from his/her glove when the pitcher holds the ball” or “in the pitching motion of the riser, the rise of the pulling arm of the pitcher is greater than that in the pitching motion of the fastball” is actually utilized as information for hitting.

On the other hand, as described in NPL 1, it is known that some batters have acquired the ability to detect habits that cannot be expressed in words by watching pitching motions of pitchers, and utilize the information of the detected habits as information when hitting.

### CITATION LIST

### Non Patent Literature

NPL 1: Toshitaka Kimura, Daiki Nasu, Masumi Yamaguchi, Makio Kashino, “Availability of Pitching Motion Information in Batting Timing Control Revealed by Virtual Reality.” Society for Neuroscience 48th Annual Meeting, Nov. 3-7, 2018, San Diego, USA.

### SUMMARY OF THE INVENTION

### Technical Problem

While a batter who has acquired the above-mentioned ability from his/her experience when he/she actually played against a pitcher can use such habit information for his/her own batting, the habit information cannot be expressed in words, and thus the habit information cannot be relayed to other batters and cannot be utilized by other batters on his/her team. This problem is not limited to competitive games such as softball and baseball in which a batter hits a ball thrown by a pitcher, but also exists in competitive games in which a player (hereinafter referred to as “player”) kinetically moves in response to an object to which motion is applied by the kinetic motion of an opposing player (hereinafter referred to as “opponent player”).

It is an object of the present invention to provide a system that allows a player to learn to utilize a habit of an opponent player in a competitive game in which the player kinetically moves in response to an object to which motion is applied by kinetic motion of the opponent player, even if the habit cannot be expressed in words.

### Means for Solving the Problem

To solve the problems described above, according to an aspect of the present invention, a kinetic motion learning system is a kinetic motion learning system for a batter to learn, in a game in which the batter hits a ball thrown by a pitcher upon selection of one of a plurality of pitching attributes, a habit of a pitching motion for each of the plurality of pitching attributes of the pitcher. The kinetic motion learning system includes a home plate defined by rules of the game, a batter's box defined by the rules of the game, a pitching machine disposed at a position of a pitcher's rubber defined by the rules of the game, a screen disposed adjacent to a home plate side of the pitching machine, a projector configured to project onto the screen, and a kinetic motion learning device connected to the pitching machine and the projector. The kinetic motion learning device includes an information storage unit configured to associate and store in advance a video of a pitching motion of a pitcher on a potential opponent team as viewed from a home plate direction for a plurality of pitches actually delivered by the pitcher (hereinafter referred to as “pitching motion video”) and information for the pitching machine to launch a ball with substantially an identical motion as a ball thrown by the pitching motion (hereinafter referred to as “pitching trajectory information”), and is configured to read a set of the pitching motion video and the pitching trajectory information stored in the information storage unit, output the pitching motion video being read to the projector, output the pitching trajectory information being read to the pitching machine, and control motion timings of the projector and the pitching machine so that a time of ball release of the pitcher in the pitching motion video displayed on the screen and a time of the pitching machine launching the ball with the pitching trajectory information match. The projector is configured to project the pitching motion video onto the screen so that the pitching motion video is displayed on the screen at a motion timing controlled by the kinetic motion learning device. The screen includes a hole through which a ball launched by the pitching machine can pass at a position of ball release of the pitcher in the pitching motion video displayed, and is configured to display the pitching motion video projected by the projector. The pitching machine is configured to launch a ball with the pitching trajectory information from the position of ball release of the pitcher in the pitching motion video displayed on the screen at a motion timing controlled by the kinetic motion learning device.

To solve the problems described above, according to another aspect of the present invention, a kinetic motion learning system is a kinetic motion learning system for a batter to learn, in a game in which the batter hits a ball thrown by a pitcher upon selection of one of a plurality of pitching attributes, a habit of a pitching motion for each of the plurality of pitching attributes of the pitcher. The kinetic motion learning system includes a head-mounted display configured to display a three-dimensional video, and a kinetic motion learning device connected to the head-mounted display. The kinetic motion learning device includes an information storage unit configured to store in advance a three-dimensional video (hereinafter referred to as “continuous three-dimensional video”) obtained by making continuous a three-dimensional video of a pitching motion for a plurality of pitches actually delivered by a pitcher on a potential opponent team and a three-dimensional video generated by computer graphics of a ball having substantially an identical motion as a ball thrown by the pitching motion, and is configured to read the continuous three-dimensional video stored in the information storage unit and output the continuous three-dimensional video being read to the head-mounted display. The head-mounted display is configured to present the continuous three-dimensional video.

To solve the problems described above, according to another aspect of the present invention, a kinetic motion learning system is a kinetic motion learning system for a player to learn, in a game in which the player kinetically moves in response to a ball launched by an opponent player upon selection of one of a plurality of attributes, a habit of a motion of the opponent player for each of the plurality of attributes. The kinetic motion learning system includes a launching device disposed in a position within a range defined by rules of the game, a screen disposed adjacent to a user side of the launching device, a projector configured to project onto the screen, and a kinetic motion learning device connected to the launching device and the projector. The kinetic motion learning device includes an information storage unit configured to associate and store in advance a video of a motion of an opponent player on a potential opponent team launching a ball as viewed from a direction of the user for a plurality of times when the opponent player actually launches a ball (hereinafter referred to as “opponent player motion video”) and information for the launching device to launch a ball with substantially an identical motion as a ball launched by the motion (hereinafter referred to as “ball trajectory information”), and is configured to read a set of the opponent player motion video and the ball trajectory information stored in the information storage unit, output the opponent player motion video being read to the projector, output the ball trajectory information being read to the launching device, and control motion timings of the projector and the launching device so that a time of the opponent player launching the ball in the opponent player motion video displayed on the screen and a time of the launching device launching the ball with the ball trajectory information match. The projector is configured to project the opponent player motion video onto the screen so that the opponent player motion video is displayed on the screen at a motion timing controlled by the kinetic motion learning device. The screen includes a hole through which a ball launched by the launching device can pass at a position where the opponent player launches the ball in the opponent player motion video displayed, and is configured to display the opponent player motion video projected by the projector. The launching device is configured to launch a ball with the ball trajectory information from the position where the opponent player launches the ball in the opponent player motion video displayed on the screen at a motion timing controlled by the kinetic motion learning device.

To solve the problems described above, according to another aspect of the present invention, a kinetic motion learning system is a kinetic motion learning system for a player to learn, in a game in which the player kinetically moves in response to a ball launched by an opponent player upon selection of one of a plurality of attributes, a habit of a motion of the opponent player for each of the plurality of attributes. The kinetic motion learning system includes a head-mounted display configured to display a three-dimensional video, and a kinetic motion learning device connected to the head-mounted display. The kinetic motion learning device includes an information storage unit configured to store in advance a three-dimensional video (hereinafter referred to as “continuous three-dimensional video”) obtained by making continuous a three-dimensional video of a motion of an opponent player on a potential opponent team launching a ball and a three-dimensional video generated by computer graphics of a ball having substantially an identical motion as a ball launched by the motion, for a plurality of times when the opponent player actually launches a ball, and is configured to read the continuous three-dimensional video stored in the information storage unit and output the continuous three-dimensional video being read to the head-mounted display. The head-mounted display is configured to present the continuous three-dimensional video.

To solve the problems described above, according to another aspect of the present invention, a kinetic motion learning system is a kinetic motion learning system for a player to learn, in a game in which the player kinetically moves in response to an object moved by an opponent player upon selection of one of a plurality of attributes, a habit of a motion of the opponent player for each of the plurality of attributes. The kinetic motion learning system includes a head-mounted display configured to display a three-dimensional video, and a kinetic motion learning device connected to the head-mounted display. The kinetic motion learning device includes an information storage unit configured to store in advance a three-dimensional video (hereinafter referred to as “continuous three-dimensional video”) obtained by making continuous a three-dimensional video of a motion of an opponent player on a potential opponent team moving an object and a three-dimensional video generated by computer graphics of an object having substantially an identical motion as an object moved by the motion, for a plurality of times when the opponent player actually moves an object, and is configured to read the continuous three-dimensional video stored in the information storage unit and output the continuous three-dimensional video being read to the head-mounted display. The head-mounted display is configured to present the continuous three-dimensional video.

### Effects of the Invention

According to the present invention, a player can learn to utilize a habit of an opponent player in a competitive game in which the player kinetically moves in response to an object to which motion is applied by kinetic motion of the opponent player, even if the habit cannot be expressed in words.

### BRIEF DESCRIPTION OF DRAWINGS

FIG. 1 is a diagram schematically illustrating an example of a kinetic motion learning system 10 for softball.

FIG. 2 is a front view schematically illustrating a screen 142.

FIG. 3 is a diagram illustrating, as an example, a functional configuration of the kinetic motion learning system 10.

FIG. 4 is a diagram illustrating, as an example, storage contents of an information storage unit 110.

FIG. 5 is a diagram illustrating a functional configuration of a computer.

### DESCRIPTION OF EMBODIMENTS

Hereinafter, embodiments of the present invention will be described with reference to the drawings using an example of a case in which the competitive game is softball.

### First Embodiment

A kinetic motion learning system according to a first embodiment is a kinetic motion learning system utilized by a batter to learn so as to utilize, in batting, information related to a habit of a pitcher, and allows the batter to watch a video of a pitching motion actually performed by the pitcher and, at the same time, visually recognize and hit a ball having substantially an identical motion as a ball actually thrown by the pitcher at the time of the pitching motion.

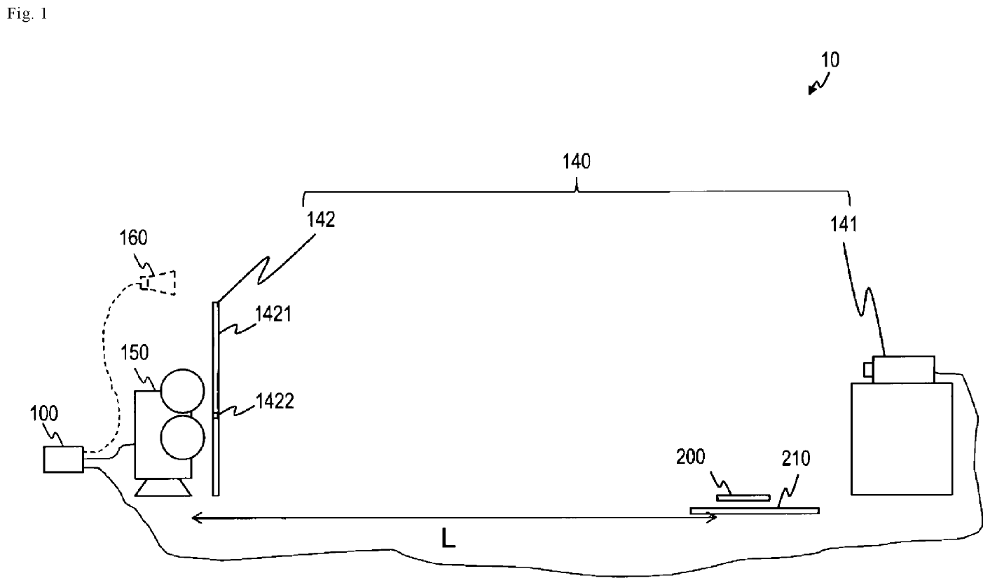

A kinetic motion learning system 10 according to the first embodiment includes a kinetic motion learning device 100, a projector 141, a home plate 200, a batter's box 210, an object presentation unit 150, and a screen 142, as schematically illustrated in FIG. 1. The kinetic motion learning device 100 is a general-purpose personal computer (PC), for example. The projector 141 is connected to the kinetic motion learning device 100. The home plate 200 is defined by game rules. The batter's box 210 is defined by the game rules, and the batter (hereinafter referred to as “user”) utilizing the kinetic motion learning system 10 stands in the batter's box 210. The object presentation unit 150 is a pitching machine disposed in a position away from the home plate 200 by a distance L from a front end of the home plate defined by the game rules to a pitcher's rubber. The screen 142 is disposed adjacent to the home plate 200 side of the object presentation unit 150, and displays video and images projected by the projector 141. The kinetic motion learning system 10 may include a sound presentation unit 160 that is a speaker disposed in a position that ensures audibility to the user and configured to emit sound, as illustrated by the dashed line in FIG. 1.

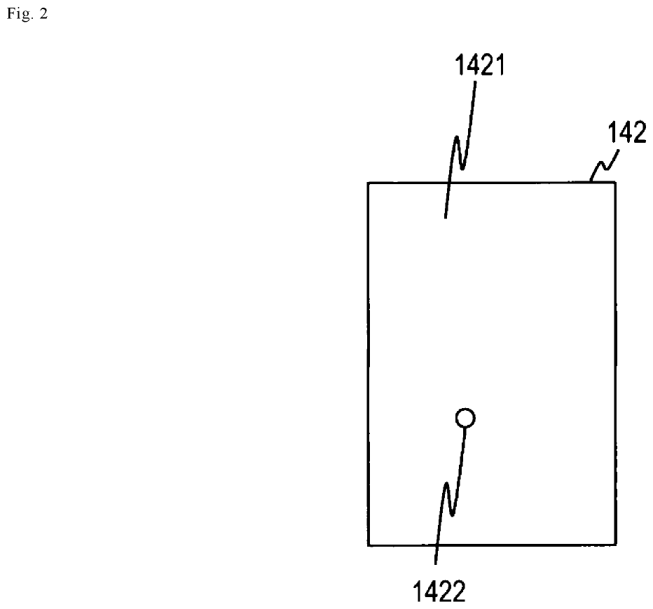

As schematically illustrated in the front view in FIG. 2, the screen 142 includes a projection surface 1421 provided with a hole 1422 sized to allow passage of a ball launched from the object presentation unit 150. The projector 141 and the screen 142 are adjusted so as to display, for example, a video of the pitching motion of a pitcher as viewed from a home plate direction at a size substantially identical to the actual size. It is important that the video of the pitching motion of a pitcher is of a size that allows the user to sense without an unnatural feeling that it is the kinetic motion of a human when the video is visually recognized, and the size may be smaller than the actual size, may be larger than the actual size, or may be adjusted as requested by the user. A position of a mechanism of the object presentation unit 150 for launching a ball and a position of the hole 1422 of the screen 142 match the position of ball release of the pitcher displayed on the screen 142. That is, the position of the mechanism of the object presentation unit 150 for launching a ball and the position of the hole 1422 of the screen 142 are the same as the actual position of ball release of the pitcher. Note that the projector 141 and the screen 142 illustrated in FIG. 1 constitute a video presentation unit 140 that is a functional component described later, and a display device of plasma, liquid crystal, or the like provided with the hole 1422 may be disposed at the position of the screen 142 as the video presentation unit 140 instead of the projector 141 and the screen 142. Note that the hole 1422 should be of the minimum size allowing passage of the ball output from the object presentation unit 150 so as not to interfere with the display of the video to the extent possible.

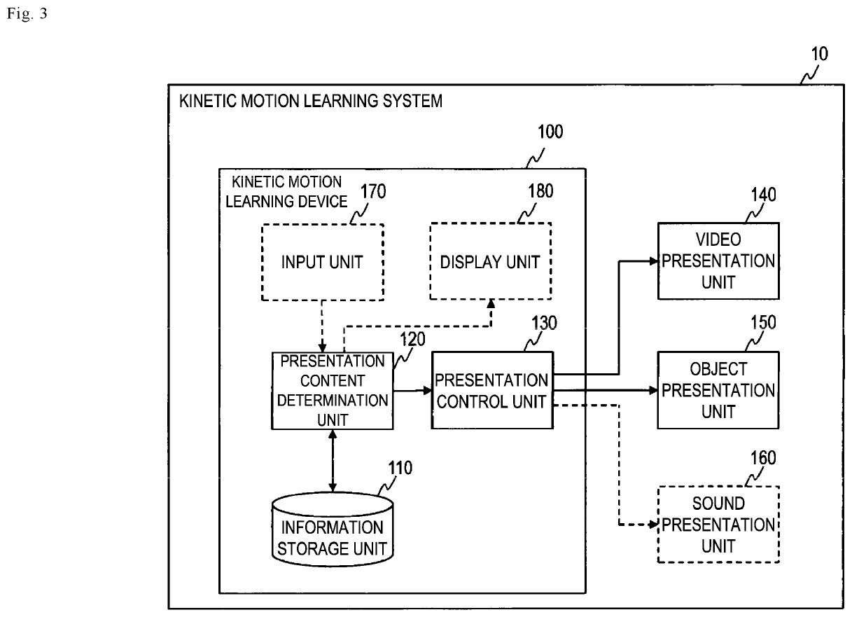

The functional configuration of the kinetic motion learning system 10 according to the first embodiment is as illustrated in FIG. 3 and includes the kinetic motion learning device 100, the video presentation unit 140, and the object presentation unit 150, and may include a sound presentation unit 160 as illustrated by the dashed line in FIG. 3.

The kinetic motion learning device 100 is, for example, a special device configured by loading a special program on a publicly known or dedicated computer including a central processing unit (CPU), a main storage device (random access memory (RAM)), and the like. The kinetic motion learning device 100 executes, for example, each process under control of the central processing unit. Data input to the kinetic motion learning device 100 and data obtained in each process are, for example, stored in the main storage device, and the data stored in the main storage device are read and utilized in other processes as necessary. Further, at least a portion of processing units of the kinetic motion learning device 100 may include hardware such as an integrated circuit.

The kinetic motion learning device 100 includes an information storage unit 110, a presentation content determination unit 120, and a presentation control unit 130. Each unit will be described below.

Information Storage Unit 110

The information storage unit 110 associates and stores in advance information related to a pitching motion, information related to a motion of a ball thrown, and attribute information related to the ball thrown, for a plurality of pitches actually delivered by a pitcher on a potential opponent team. The information related to the pitching motion is a video of the motion when the pitcher delivers the pitch. The video of the motion when the pitcher delivers the pitch is the video of the pitching motion of the pitcher as viewed from an at-bat direction, includes at least a period from a point of time when the pitcher starts the pitching motion to a point of time when the pitcher ends the pitching motion (point of time when follow-through after ball release ends), and includes the entire body of the pitcher during that period. The video of the pitching motion of the pitcher as viewed from the home plate direction may be, for example, a video captured by one camera disposed behind the backstop, or may be a video generated by known free-viewpoint video generation technology from videos captured by a plurality of cameras disposed in a plurality of locations. The information related to the motion of the thrown ball is control information for a pitching machine, which is the object presentation unit 150, to launch a ball having substantially an identical motion as the ball when delivered by the pitcher, is, for example, information for controlling a rotation applied to the ball, a speed applied to the ball, and a launching direction of the ball, and specifically is, for example, information related to a rotation applied to each rotor of the pitching machine. The attribute information of the thrown ball is information or a value related to each predetermined attribute of the thrown ball, and the predetermined attributes are, for example, a pitch type, pitch speed, and positional information in a horizontal direction (so-called “side”) and positional information in a vertical direction (so-called “height”) of a hitting position (for example, a position on a straight line including a pitcher's side of the home plate having a pentagonal shape). Hereinafter, the information related to the pitching motion is also referred to as “pitching motion information”, the information related to the motion of the thrown ball is also referred to as “pitching trajectory information”, the attributes of the thrown ball are also referred to as “pitching attributes”, and the attribute information of the thrown ball is also referred to as “pitching attribute information”. Note that, depending on the learning method, the pitching attribute information need not be stored in the information storage unit 110.

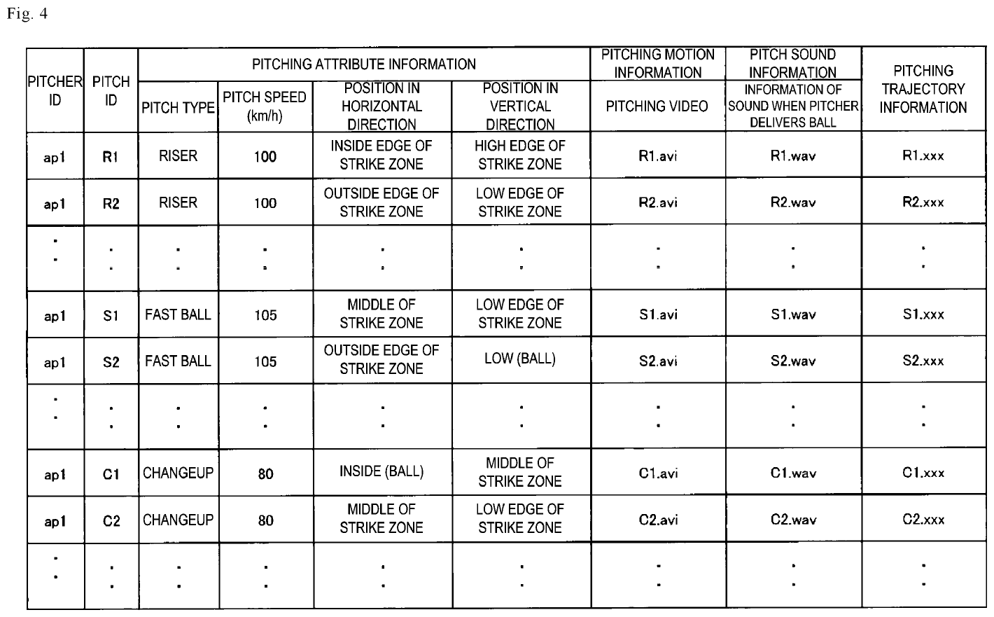

For example, as illustrated in FIG. 4, the information storage unit 110 associates, for a pitcher ap1 on a team A, a video R1.avi of the motion of the pitcher ap1 when the pitcher ap1 throws a riser (when ID=R1) as the pitching motion information, control information R1.xxx for the pitching machine, which is the object presentation unit 150, to launch a ball having substantially the identical motion as that of the riser as the pitching trajectory information, and information of various predetermined attributes of the riser such as, for example, pitch type=riser, pitch speed=100 km/h, position information in horizontal direction=inside edge of strike zone, and position in vertical direction=high edge of strike zone as the pitching attribute information, associates a video R2.avi of the motion of the pitcher ap1 when the pitcher ap1 throws the riser at a different time (when ID=R2) as the pitching motion information, control information R2.xxx for the pitching machine, which is the object presentation unit 150, to launch a ball having substantially the identical motion as that of the riser as the pitching trajectory information, and information of various predetermined attributes of the riser such as, for example, pitch type=riser, pitch speed=100 km/h, positional information in horizontal direction=outside edge of strike zone, and position in vertical direction=low edge of strike zone as the pitching attribute information, and stores the information in advance. Note that the pitching motion information, the pitching trajectory information, and the pitching attribute information may be associated and stored in the information storage unit 110 for another pitcher or a plurality of other pitchers on the team A. Further, the pitching motion information, the pitching trajectory information, and the pitching attribute information may be associated and stored in the information storage unit 110 for a pitcher or a plurality of pitchers on a team other than the team A.

Note that, in a case in which the kinetic motion learning system 10 also presents pitch sound information, which is the sound when the pitcher delivers the pitch, the information storage unit 110 associates and stores the pitch sound information in addition to the pitching motion information, the pitching trajectory information, and the pitching attribute information. The pitch sound information includes at least the sound emitted when the pitcher delivers the pitch, and may include sound emitted in the baseball park when the pitcher delivers the pitch. As illustrated in FIG. 4, the pitch sound information need only be stored as an acoustic signal R1.wav produced when the pitcher ap1 throws the riser of ID=R1, and an acoustic signal R2.wav produced when the pitcher ap1 throws the riser of ID=R2, and the like.

Presentation Content Determination Unit 120

The presentation content determination unit 120 determines the content to be presented to the user, and reads from the information storage unit 110 and outputs to the presentation control unit 130 the pitching motion information and the pitching trajectory information corresponding to the determined content, one set at a time. When the kinetic motion learning system 10 also presents the pitch sound information, the presentation content determination unit 120 reads from the information storage unit 110 and outputs to the presentation control unit 130 the pitch sound information as well.

Further, depending on the determined content, the presentation content determination unit 120, for each set, also reads the pitching attribute information from the information storage unit 110, and outputs an image and/or audio of the pitching attribute information to be presented before presentation of the pitching motion information and/or an image and/or audio of the pitching attribute information to be presented after presentation of the pitching motion information and the pitching trajectory information to the presentation control unit 130. The image of the pitching attribute information need only include all or a portion of the pitching attribute information read from the information storage unit 110 in writing, but may express a position in the horizontal direction and a position in the vertical direction at a position within a two-dimensional region including the strike zone as a rectangle or a matrix shape, or may express the pitch type as a graphic such as a circle or a triangle, for example, that is, may be any image as long as the image is capable of specifying the pitching attribute information. The audio of the pitching attribute information need only include all or a portion of the pitching attribute information read from the information storage unit 110 as audio, and audio generated from the pitching attribute information read from the information storage unit 110 by a known audio synthesis technique need only be used.

Presentation Control Unit 130

The presentation control unit 130 outputs the pitching motion information input from the presentation content determination unit 120 to the video presentation unit 140, and outputs the pitching trajectory information input from the presentation content determination unit 120 to the object presentation unit 150. When outputting the pitching motion information and pitching trajectory information, the presentation control unit 130 is also configured to control a start time of an operation for causing the video presentation unit 140 to output the video and a start time of an operation for causing the object presentation unit 150 to launch the ball, thereby matching a time of ball release in the video when the video presentation unit 140 presents the video, which is the pitching motion information, and a time at which the object presentation unit 150 launches a ball corresponding to the pitching trajectory information. By this control, the object presentation unit 150 can launch the ball at the time of ball release in the video of the pitching motion presented by the video presentation unit 140. That is, by this control, it is possible to match the timing of the ball release in the video of the pitching motion presented by the video presentation unit 140 and the timing of the launching of the ball by the object presentation unit 150.

In a case in which pitch sound information is also input from the presentation content determination unit 120, the presentation control unit 130 outputs the pitch sound information to the sound presentation unit 160. In this case, the presentation control unit 130 is also configured to control a start time of an operation for causing the video presentation unit 140 to output the video of the pitching motion information and a start time of an operation for causing the sound presentation unit 160 to output the sound of the pitch sound information, thereby synchronizing the video when the video presentation unit 140 presents the pitching motion information and the sound when the sound presentation unit 160 presents the pitch sound information.

In a case in which an image of the pitching attribute information to be presented before presentation of the pitching motion information is also input from the presentation content determination unit 120, the presentation control unit 130 also outputs the image of the pitching attribute information to the video presentation unit 140, and the video presentation unit 140 outputs the image of the pitching attribute information over a predetermined length of time. In this case, the presentation control unit 130 is also configured to control an operation for causing the video presentation unit 140 to output the video of the pitching motion information and an operation for causing the video presentation unit 140 to output the image of the pitching attribute information, thereby causing the video presentation unit 140 to output the video of the pitching motion information after output of the image of the pitching attribute information over the predetermined length of time is completed.

In a case in which an image of the pitching attribute information to be presented after presentation of the pitching motion information and the pitching trajectory information is also input from the presentation content determination unit 120, the presentation control unit 130 also outputs the image of the pitching attribute information to the video presentation unit 140, and the video presentation unit 140 outputs the image of the pitching attribute information over the predetermined length of time. In this case, the presentation control unit 130 is also configured to control an operation for causing the video presentation unit 140 to output the video of the pitching motion information and/or an operation for causing the object presentation unit 150 to launch the ball, and an operation for causing the video presentation unit 140 to output the image of the pitching attribute information, thereby starting output of the image of the pitching attribute information after the video presentation unit 140 completes output of the video of the pitching motion information and the ball corresponding to the pitching trajectory information launched by the object presentation unit 150 reaches the vicinity of the home plate 200.

In a case in which audio of the pitching attribute information to be presented before presentation of the pitching motion information is also input from the presentation content determination unit 120, the presentation control unit 130 outputs the audio of the pitching attribute information to the sound presentation unit 160. In this case, the presentation control unit 130 is also configured to control an operation for causing the video presentation unit 140 to output the video of the pitching motion information and an operation for causing the sound presentation unit 160 to output the audio of the pitching attribute information, thereby causing the video presentation unit 140 to output the video of the pitching motion information after the sound presentation unit 160 completes output of the audio of the pitching attribute information.

In a case in which audio of the pitching attribute information to be presented after presentation of the pitching motion information and the pitching trajectory information is also input from the presentation content determination unit 120, the presentation control unit 130 outputs the audio of the pitching attribute information to the sound presentation unit 160. In this case, the presentation control unit 130 is configured to control an operation for causing the video presentation unit 140 to output the video of the pitching motion information and/or an operation for causing the object presentation unit 150 to launch the ball, and an operation for causing the sound presentation unit 160 to output the audio of the pitching attribute information, thereby causing the sound presentation unit 160 to start output of the audio of the pitching attribute information after the video presentation unit 140 completes output of the video of the pitching motion information and the ball corresponding to the pitching trajectory information launched by the object presentation unit 150 reaches the vicinity of the home plate 200.

Video Presentation Unit 140

The video presentation unit 140 starts the operation of outputting the video of the pitching motion information input from the presentation control unit 130 at a time controlled by the presentation control unit 130, and displays the video of the pitching motion information. In a case in which an image of the pitching attribute information is also input from the projection control unit 130, the video presentation unit 140 performs the operation of outputting the image of the pitching attribute information as controlled by the presentation control unit 130, and displays the image of the pitching attribute information over a predetermined length of time.

Object Presentation Unit 150

The object presentation unit 150 starts the operation for outputting the ball at a time controlled by the presentation control unit 130, and launches the ball in correspondence with the pitching trajectory information input from the presentation control unit 130.

Sound Presentation Unit 160

In a case in which pitch sound information is input from the presentation control unit 130, the sound presentation unit 160 starts the operation of emitting the sound of the pitch sound information input from the presentation control unit 130 at a time controlled by the presentation control unit 130, and emits the sound of the pitch sound information input from the presentation control unit 130. Further, in a case in which audio of the pitching attribute information is input from the presentation control unit 130, the sound presentation unit 160 performs the operation of emitting the audio of the pitching attribute information as controlled by the presentation control unit 130, and emits the audio of the pitching attribute information.

### Second Embodiment

In the kinetic motion learning system 10 according to the first embodiment, the object presentation unit 150 that is a pitching machine launches the ball having substantially the identical motion as the ball actually thrown by the pitcher, but may present a video of the ball having substantially the identical motion as the ball actually thrown by the pitcher. This embodiment will be described as a second embodiment. The kinetic motion learning system according to the second embodiment is a kinetic motion learning system utilized by a batter to learn and thus be able to use, in batting, information related to a habit of a pitcher, and allows the batter to watch a video of a pitching motion actually performed by the pitcher and, at the same time, visually recognize a ball having substantially an identical motion as a ball actually thrown by the pitcher at the time of the pitching motion.

Similar to the kinetic motion learning system 10 according to the first embodiment, the functional configuration of the kinetic motion learning system 10 according to the second embodiment is as illustrated in FIG. 3, and includes the kinetic motion learning device 100, the video presentation unit 140, and the object presentation unit 150, and may include the sound presentation unit 160 as illustrated by the dashed line in FIG. 3. The kinetic motion learning device 100 includes the information storage unit 110, the presentation content determination unit 120, and the presentation control unit 130. Hereinafter, descriptions of components similar to those of the first embodiment will be omitted, and differences from the first embodiment will be primarily described.

The video presentation unit 140 and the object presentation unit 150 according to the second embodiment constitute a head-mounted display for the user to wear, that is, a device that presents a three-dimensional video that makes it possible for the user to view a video of a pitching motion actually performed by a pitcher and a video of a ball having substantially the identical motion as the ball actually thrown by the pitcher at the time of the pitching motion, at a size, depth, and motion substantially the same as those of the actual object, regardless of the position and the direction from which the user looks as a result of swinging or moving. That is, in the kinetic motion learning system 10 according to the second embodiment, one head-mounted display is commonly used as the video presentation unit 140 and the object presentation unit 150. However, it is not necessary for the user to view the three-dimensional video at substantially the same size as the actual object. It is important that the size is such that the user can sense without an unnatural feeling the kinetic motion of a human and the motion of a ball when visually recognizing the three-dimensional video, and may be smaller than the actual size, may be larger than the actual size, or may be adjusted as requested by the user.

Information Storage Unit 110

The information related to pitching motion (pitching motion information) stored in the information storage unit 110 is a three-dimensional video (hereinafter referred to as a “pitching motion three-dimensional video”) of the motion when the pitcher delivers a pitch. The information related to the motion of the thrown ball (pitching trajectory information) stored in the information storage unit 110 is a three-dimensional video (hereinafter referred to as a “pitching three-dimensional video”) obtained by generating, by computer graphics (CG), a ball having substantially the identical motion (ball having the same trajectory, for example) as that of the ball actually thrown when the pitcher delivers the pitch. The pitching motion three-dimensional video and the pitching three-dimensional video need only be stored in the information storage unit 110 as a three-dimensional video made continuous (hereinafter referred to as a “continuous three-dimensional video”).

Presentation Content Determination Unit 120

The presentation content determination unit 120 determines the content to be presented to the user, and sequentially reads from the information storage unit 110 and outputs to the presentation control unit 130 the continuous three-dimensional video corresponding to the determined content, one video at a time. When the kinetic motion learning system 10 also presents the pitch sound information, the presentation content determination unit 120 reads from the information storage unit 110 and outputs to the presentation control unit 130 the pitch sound information as well. Further, in a case in which the kinetic motion learning system 10 presents an image and/or audio of the pitching attribute information before presenting the pitching motion information (in the case of the present embodiment, actually the continuous three-dimensional video that is a video including the pitching motion information) and/or after presenting the pitching motion information and the pitching trajectory information (in the case of the present embodiment, actually the continuous three-dimensional video that is a video including the pitching motion information and the pitching trajectory information), the presentation content determination unit 120 reads the pitching attribute information from the information storage unit 110 and outputs the image and/or the audio of the pitching attribute information to the presentation control unit 130.

Presentation Control Unit 130

The presentation control unit 130 outputs the continuous three-dimensional video input from the presentation content determination unit 120 to the head-mounted display that is the video presentation unit 140 and the object presentation unit 150. In a case in which pitch sound information is also input from the presentation content determination unit 120, the presentation control unit 130 outputs the pitch sound information to the sound presentation unit 160. In this case, the sound presentation unit 160 is a speaker included in the head-mounted display, for example.

In a case in which an image of the pitching attribute information to be presented before presentation of the pitching motion information and/or an image of the pitching attribute information to be presented after presentation of the pitching motion information and the pitching trajectory information are also input from the presentation content determination unit 120, the presentation control unit 130 also outputs the image of the pitching attribute information to the head-mounted display. In this case, the presentation control unit 130 performs control so that the image of the pitching attribute information is output over a predetermined length of time before and/or after the head-mounted display presents the continuous three-dimensional video.

In a case in which audio of the pitching attribute information to be presented before presentation of the pitching motion information and/or audio of the pitching attribute information to be presented after presentation of the pitching motion information and the pitching trajectory information are also input from the presentation content determination unit 120, the audio of the pitching attribute information is output to the sound presentation unit 160. In this case, the presentation control unit 130 performs control so that the sound presentation unit 160 completes output of the audio of the pitching attribute information before the head-mounted display presents the continuous three-dimensional video and/or the sound presentation unit 160 starts output of the audio of the pitching attribute information after the head-mounted display outputs the continuous three-dimensional video.

### Third Embodiment

In a third embodiment, a learning method performed by the kinetic motion learning system 10 according to the first embodiment and the second embodiment will be described. The kinetic motion learning system 10 according to the first embodiment and the second embodiment is configured to determine the content to be presented by the presentation content determination unit 120 to the user in accordance with various learning methods described in the third embodiment, making it possible for the user to learn by each learning method the pitching of a pitcher on a potential opponent team, such as, for example, the pitching of the pitcher ap1 on the team A illustrated in FIG. 4. In a case in which the learning method, the pitch type, and the like can be selected, for example, an input unit 170 and a display unit 180 may also be provided in the kinetic motion learning device 100 as indicated by the dashed lines in FIG. 3, the display unit 180 may display a plurality of learning methods stored in a storage unit (not illustrated) within the presentation content determination unit 120 as options and display options, such as pitch type, in each learning method, the input unit 170 may receive a selection operation by the user or the like for the options displayed on the display unit 180, and the presentation content determination unit 120 may determine the content to be presented to the user in accordance with the learning method, the pitch type, and the like corresponding to the selection operation received by the input unit 170.

First Learning Method

A first learning method is a method in which the user learns in a setting in which a pitcher continuously delivers one pitch type. For example, the method is one in which the user continuously learns only the riser of the pitcher ap1, and more specifically is one in which the user practices hitting pitches delivered in the order of the pitch IDs R1, R2, . . . , in FIG. 4. According to this learning method, the user can master appropriate hitting with respect to the pitching motion of the pitcher for that pitch type.

When this learning method is used, the presentation content determination unit 120 need only be configured to, for example, cause the display unit 180 to display, as options, a plurality of pitch types included in the pitching attribute information stored in the information storage unit 110, determine the pitch type corresponding to the selection operation received by the input unit 170 as a pitch type for learning, read the sets of the pitching motion information and the pitching trajectory information corresponding to the determined pitch type from the information storage unit 110 one set at a time, and output the read pitching motion information and pitching trajectory information to the presentation control unit 130. Note that in a case in which the number of sets to be read that are stored in the information storage unit 110 is less than the number of times required for learning, the presentation content determination unit 120 need only be configured to repeatedly output the sets to be read that are stored in the information storage unit 110.

For example, in a case in which the stored content of the information storage unit 110 is that illustrated in FIG. 4, the presentation content determination unit 120 need only display riser, fastball, and changeup as options on the display unit 180. Then, in a case in which the pitch type corresponding to the selection operation received by the input unit 170 is riser, the presentation content determination unit 120 need only perform an operation such as reading and outputting to the presentation control unit 130 the set of the pitching motion information R1.avi and the pitching trajectory information R1.xxx, then reading and outputting to the presentation control unit 130 the set of the pitching motion information R2.avi and the pitching trajectory information R2.xxx, . . . , and, after completing the reading of all sets for the riser stored in the information storage unit 110, further reading and outputting to the presentation control unit 130 the set of the pitching motion information R1.avi and the pitching trajectory information R1.xxx, then reading and outputting to the presentation control unit 130 the set of the pitching motion information R2.avi and the pitching trajectory information R2.xxx, and the like.

Second Learning Method

A second learning method is a method in which the user learns in a setting in which two or more pitch types are repeatedly delivered in the same order. For example, the method is one in which the user alternately learns the riser and the fastball of the pitcher ap1, and more specifically is one in which the user practices hitting pitches delivered in the order of the pitch IDs R1, S1, R2, S2, . . . , in FIG. 4. According to this learning method, it is expected that the user will naturally master differences in delivery form by pitch type by regularly repeating the delivery form of a plurality of pitch types.

When this learning method is used, the presentation content determination unit 120 need only be configured to, for example, cause the display unit 180 to display, as options, a plurality of pitch types included in the pitching attribute information stored in the information storage unit 110, determine a plurality of pitch types corresponding to the selection operation received by the input unit 170 as a plurality of pitch types for learning, determine a presentation order of the determined plurality of pitch types for learning, sequentially read, from the information storage unit 110, the sets of the pitching motion information and the pitching trajectory information of the pitch types corresponding to the determined presentation order, and output the read pitching motion information and pitching trajectory information to the presentation control unit 130. Note that in a case in which the number of sets to be read that are stored in the information storage unit 110 is less than the number of times required for learning, the presentation content determination unit 120 need only be configured to repeatedly output the sets to be read that are stored in the information storage unit 110.

For example, in a case in which the stored content of the information storage unit 110 is that illustrated in FIG. 4, the presentation content determination unit 120 need only display riser, fastball, and changeup as options on the display unit 180. Then, in a case in which the pitch types corresponding to the selection operation received by the input unit 170 are riser and fastball, the presentation content determination unit 120 need only perform an operation such as reading and outputting to the presentation control unit 130 the set of the pitching motion information R1.avi and the pitching trajectory information R1.xxx, then reading and outputting to the presentation control unit 130 the set of pitching motion information S1.avi and pitching trajectory information S1.xxx, then reading and outputting to the presentation control unit 130 the set of the pitching motion information R2.avi and the pitching trajectory information R2.xxx, then reading and outputting to the presentation control unit 130 the set of pitching motion information S2.avi and pitching trajectory information S2.xxx, . . . , and, after completing the reading of all sets for the riser and the fastball stored in the information storage unit 110, further reading and outputting to the presentation control unit 130 the set of the pitching motion information R1.avi and the pitching trajectory information R1.xxx, then reading and outputting to the presentation control unit 130 the set of the pitching motion information S1.avi and the pitching trajectory information S1.xxx, and the like.

Third Learning Method

A third learning method is a method in which the user learns in a setting in which two or more pitch types are randomly delivered. According to this third learning method, as with the second learning method, it is expected that the user will naturally master differences in delivery form by pitch type. However, the third learning method has better learning efficiency and a greater sustaining effect than the second learning method.

When this learning method is used, the presentation content determination unit 120 randomly reads the sets of the pitching motion information and the pitching trajectory information stored in the information storage unit 110 one set at a time, and outputs the read pitching motion information and pitching trajectory information to the presentation control unit 130. When the pitch types are to be specified by the user or the like, the presentation content determination unit 120 need only be configured to, for example, cause the display unit 180 to display, as options, a plurality of pitch types included in the pitching attribute information stored in the information storage unit 110, determine the plurality of pitch types corresponding to the selection operation received by the input unit 170 as a plurality of pitch types for learning, randomly read the sets of the pitching motion information and the pitching trajectory information stored in the information storage unit 110 one set at a time, and output the read pitching motion information and pitching trajectory information to the presentation control unit 130.

Fourth Learning Method

A fourth learning method is a method in which the user learns in a setting in which, similar to the third learning method, two or more pitch types are randomly delivered, but differs from the third learning method in that the user is informed of the pitching attribute information including the information related to pitch type before the pitch is delivered. According to this learning method, because the user hits in response to each delivery with knowledge of the pitch type and the like ahead of time, it is expected that a batting success rate will rise due to the ease at which the batter times the hitting and the like and that the user will learn the delivery form of the pitcher in accordance with successful experiences in hitting.

When this learning method is used, the presentation content determination unit 120 randomly reads the sets of the pitching motion information, the pitching trajectory information, and the pitching attribute information stored in the information storage unit 110 one set at a time, and outputs, to the presentation control unit 130, the read pitching motion information and pitching trajectory information as well as an image and/or audio of the pitching attribute information to be presented before presentation of the pitching motion information. The presentation content determination unit 120 may include only a portion of the pitching attribute information stored in the information storage unit 110 in the image and/or the audio of the pitching attribute information. That is, the pitching attribute information to be presented using the image and/or the audio by the kinetic motion learning system 10 may be all or a portion of that stored in the information storage unit 110, and, for example, the kinetic motion learning system 10 may be configured to present only the pitch type and the pitch speed, or may be configured to also present positional information in the horizontal direction and positional information in the vertical direction.

Fifth Learning Method

A fifth learning method is a method in which the user learns in a setting in which, similar to the third and fourth learning methods, two or more pitch types are randomly delivered, but differs from the third and fourth learning methods in that the user is informed of the pitching attribute information including the information related to pitch type after the pitch is delivered. According to this learning method, there is an effect of preventing erroneous learning by clearly notifying the user of the fact that the pitch was a certain type. Further, the user finds out the pitch type after failing to hit a certain pitch, resulting in the effect of providing, to the user, a hint to the reason for the failure, facilitating success of the next hit.

In the case of this learning method, the presentation content determination unit 120 randomly reads the sets of the pitching motion information, the pitching trajectory information, and the pitching attribute information stored in the information storage unit 110 one set at a time, and outputs, to the presentation control unit 130, the read pitching motion information and pitching trajectory information as well as an image and/or audio of the pitching attribute information to be presented after presentation of the pitching motion information and the pitching trajectory information. The presentation content determination unit 120 may include only a portion of the pitching attribute information stored in the information storage unit 110 in the image and/or the audio of the pitching attribute information. That is, the pitching attribute information to be presented using the image and/or the audio by the kinetic motion learning system 10 may be all or a portion of that stored in the information storage unit 110, and, for example, the kinetic motion learning system 10 may be configured to present only the pitch type and the pitch speed, or may be configured to also present positional information in the horizontal direction and positional information in the vertical direction.

Sixth Learning Method

A sixth learning method is a method in which the user learns in a setting in which, similar to the third to fifth learning methods, two or more pitch types are randomly delivered, but differs from the third to fifth learning methods in that the user is informed of the pitching attribute information both before and after the pitch is delivered. In the case of this learning method, the presentation content determination unit 120 randomly reads the sets of the pitching motion information, the pitching trajectory information, and the pitching attribute information stored in the information storage unit 110 one set at a time, and outputs, to the presentation control unit 130, the read pitching motion information and pitching trajectory information as well as an image and/or audio of the pitching attribute information to be presented before presentation of the pitching motion information and an image and/or audio of the pitching attribute information to be presented after presentation of the pitching motion information and the pitching trajectory information. The presentation content determination unit 120 may include only a portion of the pitching attribute information stored in the information storage unit 110 in the image and/or the audio of the pitching attribute information. That is, the pitching attribute information to be presented using the image and/or the audio by the kinetic motion learning system 10 may be all or a portion of that stored in the information storage unit 110, and, for example, the kinetic motion learning system 10 may be configured to present only the pitch type and the pitch speed, or may be configured to also present positional information in the horizontal direction and positional information in the vertical direction.

Further, the presentation content determination unit 120 may differentiate all or a portion of the pitching attribute information included in the image and/or the audio of the pitching attribute information to be presented before presentation of the pitching motion information and the image and/or the audio of the pitching attribute information to be presented after presentation of the pitching motion information and the pitching trajectory information. That is, the pitching attribute information presented in the image and/or the audio by the kinetic motion learning system 10 may be information that differs in whole or in part before the pitch is delivered and after the pitch is delivered, and, for example, the kinetic motion learning system 10 may be configured to present positional information in the horizontal direction and positional information in the vertical direction before the pitch is delivered, and to present the pitch type and the pitch speed after the pitch is delivered.

Further, the presentation content determination unit 120 may also include a greater amount of the pitching attribute information included in the image and/or the audio of the pitching attribute information to be presented after presentation of the pitching motion information and the pitching trajectory information than the pitching attribute information included in the image and/or the audio of the pitching attribute information to be presented before presentation of the pitching motion information. That is, the amount of the pitching attribute information presented in the image and/or the audio by the kinetic motion learning system 10 may be greater after the pitch is delivered than that before the pitch is delivered, and, for example, the kinetic motion learning system 10 may be configured to present the positional information in the horizontal direction and the positional information in the vertical direction before the pitch is delivered, and the pitch type, the pitch speed, the positional information in the horizontal direction, and the positional information in the vertical direction after the pitch is delivered.

Seventh Learning Method

A seventh learning method is a method in which the user learns in a setting in which, similar to the third to sixth learning methods, two or more pitch types are randomly delivered, but differs from the third to sixth learning methods in that the informed pitching attribute information decreases as learning progresses. In the case of this learning method, the presentation content determination unit 120 randomly reads the sets of the pitching motion information and the pitching trajectory information stored in the information storage unit 110 one set at a time, and outputs the read pitching motion information and pitching trajectory information to the presentation control unit 130. In this case, the presentation content determination unit 120 decreases the amount of pitching attribute information included in the image and/or the audio of the pitching attribute information as the number of pitches delivered increases, and therefore sometimes reads the pitching attribute information from the information storage unit 110 and outputs, to the presentation control unit 130, the image and/or the audio of the pitching attribute information to be presented before presentation of the pitching motion information and/or the image and/or the audio of the pitching attribute information to be presented after presentation of the pitching motion information and the pitching trajectory information, and sometimes does not read the pitching attribute information from the information storage unit 110 or output either the image or the audio of the pitching attribute information to the presentation control unit 130. For example, the presentation content determination unit 120 may be configured to include all pitching attribute information stored in the information storage unit 110 for the first 20 pitches and include the pitch type and the pitch speed of the pitching attribute information stored in the information storage unit 110 for the next 20 pitches in the image and/or the audio of pitching attribute information, and not output the image and/or the audio of the pitching attribute information for the next 20 pitches. That is, the kinetic motion learning system 10 may be configured to present all pitching attribute information stored in the information storage unit 110 in the image and/or the audio for the first 20 pitches, present the pitch type and the pitch speed of the pitching attribute information stored in the information storage unit 110 for the next 20 pitches, and not present the pitching attribute information for the next 20 pitches.

Note that, in the description of the first to seventh methods described above, description has been made with a focus on pitch type, but “pitch type” in the first to seventh methods described above may be replaced with an attribute other than pitch type and may be replaced with a combination of a plurality of attributes.

### Fourth Embodiment

The kinetic motion learning system and learning method according to the present invention are not limited to softball described above, and can be implemented as long as the competitive game is one in which the player kinetically moves in response to a ball launched by kinetic motion of the opponent player. Such a kinetic motion learning system similar to that of the first embodiment for a competitive game will be described as a fourth embodiment. Examples of such a competitive game are tennis, table tennis, badminton, volleyball, handball, and soccer. For example, in the case of an easy return or serve in tennis, table tennis, or volleyball, a penalty shot in handball, or a penalty kick in soccer, the motion of launching the ball includes an attribute-adapted portion dependent on the attribute, such as the ball type attempted to be launched (is the attempt to hit the ball, to kick the ball, to throw the ball, or the like?) and the position attempted to be reached. Badminton uses a shuttlecock as a ball, but is similar to the sports such as tennis, table tennis, and volleyball mentioned above. Further, for practicing these games, there are launching devices capable of launching balls having various attributes, similar to softball and baseball pitching machines. That is, as long as the object presentation unit that is a launching device is disposed at any position (position where the opponent player is supposed to hit, throw, kick, or the like) within a range defined by the game rules (the range in which the opponent player may be present such as a court or a field) and a screen is provided adjacent to a user side of the object presentation unit, a kinetic motion learning system similar to the kinetic motion learning system 10 according to the first embodiment can be realized and the learning method according to the third embodiment by the kinetic motion learning system 10 according to the first embodiment can be implemented for any of the games described above.

That is, the kinetic motion learning system according to the fourth embodiment is a kinetic motion learning system for a player to learn, in a game in which the player kinetically moves in response to a ball launched by an opponent player upon selection of one of a plurality of attributes, a habit of a motion of the opponent player for each of the plurality of attributes, and includes a launching device disposed in a position within a range defined by rules of the game, a screen disposed adjacent to a user side of the launching device, a projector configured to project onto the screen, and a kinetic motion learning device connected to the launching device and the projector. The kinetic motion learning device includes an information storage unit configured to associate and store in advance a video of a motion of an opponent player on a potential opponent team launching a ball as viewed from a direction of the user for a plurality of times when the opponent player actually launches a ball (hereinafter referred to as “opponent player motion video”) and information for the launching device to launch a ball with substantially an identical motion as a ball launched by the motion (hereinafter referred to as “ball trajectory information”). Then, the kinetic motion learning device is configured to read a set of the opponent player motion video and the ball trajectory information stored in the information storage unit, output the opponent player motion video being read to the projector, output the ball trajectory information being read to the launching device, and control motion timings of the projector and the launching device so that a time of the opponent player launching the ball in the opponent player motion video displayed on the screen and a time of the launching device launching the ball with the ball trajectory information match. The projector is configured to project the opponent player motion video onto the screen so that the opponent player motion video is displayed on the screen at a motion timing controlled by the kinetic motion learning device. The screen includes a hole through which a ball launched by the launching device can pass at a position where the opponent player launches the ball in the opponent player motion video displayed, and is configured to display the opponent player motion video projected by the projector. The launching device is configured to launch a ball with the ball trajectory information from the position where the opponent player launches the ball in the opponent player motion video displayed on the screen at a motion timing controlled by the kinetic motion learning device.

### Fifth Embodiment

A kinetic motion learning system similar to that of the second embodiment for a competitive game described in the fourth embodiment will be described as a fifth embodiment.

The kinetic motion learning system according to the fifth embodiment is a kinetic motion learning system for a player to learn, in a game in which the player kinetically moves in response to a ball launched by an opponent player upon selection of one of a plurality of attributes, a habit of a motion of the opponent player for each of the plurality of attributes, and includes a head-mounted display configured to display a three-dimensional video, and a kinetic motion learning device connected to the head-mounted display. The kinetic motion learning device includes an information storage unit configured to store in advance a three-dimensional video (hereinafter referred to as “continuous three-dimensional video”) obtained by making continuous a three-dimensional video of a motion of an opponent player on a potential opponent team launching a ball and a three-dimensional video generated by computer graphics of a ball having substantially an identical motion as a ball launched by the motion, for a plurality of times when the opponent player actually launches a ball. Then, the kinetic motion learning device is configured to read the continuous three-dimensional video stored in the information storage unit and output the continuous three-dimensional video being read to the head-mounted display. The head-mounted display is configured to present the continuous three-dimensional video being input.

### Sixth Embodiment

Instead of the ball launched by the kinetic motion of the opponent player in the kinetic motion learning system according to the fifth embodiment, an object imparted with motion by the kinetic motion of the opponent player may be used. That is, the kinetic motion learning system and learning method of the present invention can be implemented as long as the game is a competitive game in which the player kinetically moves in response to an object imparted with motion by the kinetic motion of the opponent player. Such a kinetic motion learning system similar to that of the fifth embodiment for a competitive game will be described as a sixth embodiment.

The kinetic motion learning system according to the sixth embodiment is a kinetic motion learning system for a player to learn, in a game in which the player kinetically moves in response to an object moved by an opponent player upon selection of one of a plurality of attributes, a habit of a motion of the opponent player for each of the plurality of attributes, and includes a head-mounted display configured to display a three-dimensional video, and a kinetic motion learning device connected to the head-mounted display. The kinetic motion learning device includes an information storage unit configured to store in advance a three-dimensional video (hereinafter referred to as “continuous three-dimensional video”) obtained by making continuous a three-dimensional video of a motion of an opponent player on a potential opponent team moving an object and a three-dimensional video generated by computer graphics of an object having substantially an identical motion as an object moved by the motion, for a plurality of times when the opponent player actually moves an object. Then, the kinetic motion learning device is configured to read the continuous three-dimensional video stored in the information storage unit and output the continuous three-dimensional video being read to the head-mounted display. The head-mounted display is configured to present the continuous three-dimensional video being input.

Program and Recording Medium

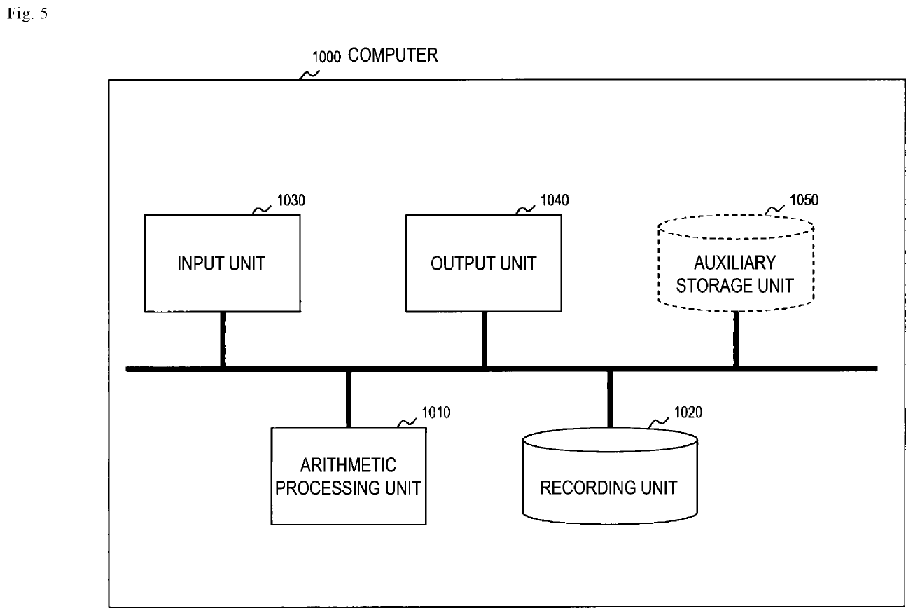

In a case in which various processing functions in each kinetic motion learning device described in the foregoing embodiments are implemented by a computer, processing details of the functions that each kinetic motion learning device are described by a program. Then, by causing this program to be read into a storage unit 1020 of the computer illustrated in FIG. 5 and causing an arithmetic processing unit 1010, an input unit 1030, an output unit 1040, and the like to operate, various processing functions of each of the kinetic motion learning devices described above are implemented on the computer.

The program in which the processing details are described can be recorded on a computer-readable recording medium. The computer-readable recording medium is, for example, a non-temporary recording medium, specifically, a magnetic recording device, an optical disk, or the like.

In addition, the program is distributed, for example, by selling, transferring, or lending a portable recording medium such as a DVD or a CD-ROM with the program recorded on it. Further, the program may be stored in a storage device of a server computer and transmitted from the server computer to another computer via a network, so that the program is distributed.

For example, a computer executing such a program first temporarily stores the program recorded on the portable recording medium or the program transmitted from the server computer in an auxiliary recording unit 1050 that is its own non-temporary storage device. Then, when executing the processing, the computer reads the program stored in the auxiliary recording unit 1050 that is its own storage device to the storage unit 1020 and executes the processing in accordance with the read program. Further, as another execution mode of this program, the computer may directly read the program from the portable recording medium to the storage unit 1020 and execute processing in accordance with the program, or, further, may sequentially execute the processing in accordance with the received program each time the program is transferred from the server computer to the computer. In addition, another configuration may be employed to execute the processing through a so-called application service provider (ASP) service in which processing functions are implemented just by issuing an instruction to execute the program and obtaining results without transmitting the program from the server computer to the computer. Further, the program in this mode is assumed to include information which is provided for processing of a computer and is equivalent to a program (data or the like that has characteristics of regulating processing of the computer rather than being a direct instruction to the computer).

In addition, although the device is configured by executing a predetermined program on a computer in this mode, at least a part of the processing details may be implemented by hardware.

1. A kinetic motion learning system for a batter to learn, in a game in which the batter hits a ball thrown by a pitcher upon selection of one of a plurality of pitching attributes, a habit of a pitching motion for each of the plurality of pitching attributes of the pitcher, the kinetic motion learning system comprising:
a home plate defined by rules of the game;
a batter's box defined by the rules of the game;
a pitching machine disposed in a position of a pitcher's rubber defined by the rules of the game;
a screen disposed adjacent to a home plate side of the pitching machine;
a projector configured to project onto the screen; and
a kinetic motion learning device connected to the pitching machine and the projector,
wherein the kinetic motion learning device comprises a processor configured to execute a method comprising:
storing in advance a video of a pitching motion of a pitcher on a potential opponent team as viewed from a home plate direction for a plurality of pitches actually delivered by the pitcher (hereinafter referred to as “pitching motion video”) and information for the pitching machine to launch a ball with substantially an identical motion as a ball thrown by the pitching motion (hereinafter referred to as “pitching trajectory information”),
retrieving a set of the pitching motion video and the pitching trajectory information,
outputting the retrieved pitching motion video to the projector,
outputting the pitching trajectory information being read to the pitching machine,
controlling a motion timing of the projector and the pitching machine so that a time of ball release of the pitcher in the pitching motion video displayed on the screen and a time of the pitching machine launching the ball with the pitching trajectory information match,
projecting, by the projector, the pitching motion video onto the screen so that the pitching motion video is displayed on the screen at a motion timing controlled by the kinetic motion learning device,
the screen includes a hole through which a ball launched by the pitching machine can pass at a position of ball release of the pitcher in the pitching motion video displayed, and the screen displays the pitching motion video projected by the projector, and
the pitching machine is configured to launch a ball with the pitching trajectory information from the position of ball release of the pitcher in the pitching motion video displayed on the screen at a motion timing controlled by the kinetic motion learning device.

2. A kinetic motion learning system for a batter to learn, in a game in which the batter hits a ball thrown by a pitcher upon selection of one of a plurality of pitching attributes, a habit of a pitching motion for each of the plurality of pitching attributes of the pitcher, the kinetic motion learning system comprising:
a processor configured to execute a method comprising:
displaying, using a head-mounted display a three-dimensional video;
connecting a kinetic motion learning device to the head-mounted display;
storing, by the kinetic motion learning device in advance a three-dimensional video (hereinafter referred to as “continuous three-dimensional video”) obtained by making continuous a three-dimensional video of a pitching motion and a three-dimensional video generated by computer graphics of a ball having substantially an identical motion as a ball thrown by the pitching motion, for a plurality of pitches actually delivered by a pitcher on a potential opponent team;
reading, by the kinetic motion learning device, the continuous three-dimensional video;
outputting the continuous three-dimensional video being read to the head-mounted displays; and
causing the head-mounted display to present the continuous three-dimensional video.

3. The kinetic motion learning system according to claim 1, the processor further configured to execute a method comprising:
sequentially reading and outputting a set of the pitching motion video and the pitching trajectory information, or the continuous three-dimensional video, for a plurality of pitches of one pitch type of the pitcher.

4. The kinetic motion learning system according to claim 1, the processor further configured to execute a method comprising:
sequentially reading and outputting, in a predetermined pitch type sequence, a set of the pitching motion video and the pitching trajectory information, or the continuous three-dimensional video, for a plurality of pitches of respective two or more pitch types of the pitcher.

5. The kinetic motion learning system according to claim 1, the processor further configured to execute a method comprising:
reading and outputting, in a random sequence, a set of the pitching motion video and the pitching trajectory information, or the continuous three-dimensional video, for a plurality of pitches of respective two or more pitch types of the pitcher.

6. A kinetic motion learning system for a player to learn, in a game in which the player kinetically moves in response to a ball launched by an opponent player upon selection of one of a plurality of attributes, a habit of a motion of the opponent player for each of the plurality of attributes, the kinetic motion learning system comprising:
a launching device disposed in a position within a range defined by rules of the game;
a screen disposed adjacent to a user side of the launching device;
a projector configured to project onto the screen; and
a kinetic motion learning device connected to the launching device and the projector,
the kinetic motion learning device comprises a processor configured to execute a method comprising:
associating and storing in advance a video of a motion of an opponent player on a potential opponent team launching a ball as viewed from a direction of the user for a plurality of times when the opponent player actually launches a ball (hereinafter referred to as “opponent player motion video”) and information for the launching device to launch a ball with substantially an identical motion as a ball launched by the motion (hereinafter referred to as “ball trajectory information”),
reading a set of the opponent player motion video and the ball trajectory information,
outputting the opponent player motion video being read to the projector, output the ball trajectory information being read to the launching device,
controlling a motion timing of the projector and the launching device so that a time of the opponent player launching the ball in the opponent player motion video displayed on the screen and a time of the launching device launching the ball with the ball trajectory information match,
projecting, by the projector the opponent player motion video onto the screen so that the opponent player motion video is displayed on the screen at a motion timing controlled by the kinetic motion learning device,
the screen includes a hole through which a ball launched by the launching device can pass at a position where the opponent player launches the ball in the opponent player motion video displayed, and the screen displays the opponent player motion video projected by the projector, and
launching, by the launching device, a ball with the ball trajectory information from the position where the opponent player launches the ball in the opponent player motion video displayed on the screen at a motion timing controlled by the kinetic motion learning device.

7-8. (canceled)

9. The kinetic motion learning system according to claim 1, wherein the pitching motion video is based on the habit of a motion of the pitcher.

10. The kinetic motion learning system according to claim 2, the processor further configured to execute a method comprising:
sequentially reading and outputting a set of the pitching motion video and the pitching trajectory information, or the continuous three-dimensional video, for a plurality of pitches of one pitch type of the pitcher.

11. The kinetic motion learning system according to claim 2, the processor further configured to execute a method comprising:
sequentially reading and outputting, in a predetermined pitch type sequence, a set of the pitching motion video and the pitching trajectory information, or the continuous three-dimensional video, for a plurality of pitches of respective two or more pitch types of the pitcher.

12. The kinetic motion learning system according to claim 2, the processor further configured to execute a method comprising: reading and outputting, in a random sequence, a set of the pitching motion video and the pitching trajectory information, or the continuous three-dimensional video, for a plurality of pitches of respective two or more pitch types of the pitcher.

13. The kinetic motion learning system according to claim 6, the processor further configured to execute a method comprising:
sequentially reading and outputting a set of the pitching motion video and the pitching trajectory information, or the continuous three-dimensional video, for a plurality of pitches of one pitch type of the pitcher.

14. The kinetic motion learning system according to claim 6, the processor further configured to execute a method comprising:
sequentially reading and outputting, in a predetermined pitch type sequence, a set of the pitching motion video and the pitching trajectory information, or the continuous three-dimensional video, for a plurality of pitches of respective two or more pitch types of the pitcher.

15. The kinetic motion learning system according to claim 6, the processor further configured to execute a method comprising: reading and outputting, in a random sequence, a set of the pitching motion video and the pitching trajectory information, or the continuous three-dimensional video, for a plurality of pitches of respective two or more pitch types of the pitcher.

16. The kinetic motion learning system according to claim 6, wherein the opponent player motion video includes the opponent player throwing the ball toward the player.

17. The kinetic motion learning system according to claim 6, wherein the opponent player motion video includes the opponent player kicking the ball toward the player as a penalty kick in playing soccer.

18. The kinetic motion learning system according to claim 6, wherein the opponent player motion video includes the opponent player kicking the ball toward the player.

19. The kinetic motion learning system according to claim 6, wherein the opponent player motion video includes the opponent player hitting the ball with a tennis racket toward the player.

20. The kinetic motion learning system according to claim 6, wherein the opponent player motion video includes the opponent player hitting the ball toward the player as a serve in playing tennis.

21. The kinetic motion learning system according to claim 6, wherein the opponent player motion video is based on the habit of a motion of the opponent player.

22. The kinetic motion learning system according to claim 6, wherein the opponent player motion video is based on the habit of a motion of the opponent player.
